(19) United States
(12) Patent Application Publication
(10) Pub. No.: US 2026/0322862 A1
(43) Pub. Date: Oct. 15, 2026

(54) METHOD, APPARATUS, DEVICE, MEDIUM AND PRODUCT FOR PROCESSING LAYOUT OF MEDIA STREAM

(71) Applicant: Beijing Zitiao Network Technology Co., Ltd., Beijing (CN)

(72) Inventor: Jian LIU, Beijing (CN)

(21) Appl. No.: 19/646,433

(22) Filed: Apr. 13, 2026

(30) Foreign Application Priority Data
Apr. 11, 2025 (CN) 2025104589600

(51) Int. Cl. H04L 65/1089; H04L 65/403

(52) U.S. Cl. CPC H04L 65/1089; H04L 65/403

(57) ABSTRACT

Embodiments of the present disclosure relate to a method, an apparatus, a device, a medium and a product for processing a layout of a media stream. The method includes sending, from a client to a server, a request associated with a live streaming to receive, from the server, a layout identification corresponding to a target layout of a set of media streams of a set of users in the live streaming. The method further includes, in response to there being a set of configuration template files for a layout of a media stream of the live streaming at the client, determining, based on the layout identification, whether the set of configuration template files include the target layout.

### CROSS-REFERENCE TO RELATED APPLICATIONS

This application claims priority to CN Application No. 202510458960.0 filed in Apr. 11, 2025, the disclosure of which is incorporated herein by reference in its entity.

### TECHNICAL FIELD

Embodiments of the present disclosure generally relate to the technical field of audio and video processing and live streaming, and in particular, to a method, an apparatus, a device, a medium and a product for processing a layout of a media stream.

### BACKGROUND

With the continuous development of audio and video technologies and live streaming technologies, application scenarios of online live streaming, video conferences and remote interactions are increasing day by day, and have become an important part of online communication today. Various social platform live streaming, online education systems, remote office software and the like have put forward higher requirements for high-quality media stream transmission and interactive experience. In the live streaming industry, multi-user interaction has become the main development direction, and real-time connections and interactions between streamers, audiences and guests have become more diverse, and many more flexible and intelligent solutions have been created for video layout in different scenarios.

With the development of globalization, various live streaming and video conference systems need to support efficient layout management in multi-terminal and multi-network environments, so as to ensure reasonable display of images, meet the effect requirements that streamers want, and ensure smooth experience of users. At the same time, with the popularization of intelligent terminals and mobile networks, audio and video interaction experience is constantly evolving in the direction of clearer, lower latency and more immersive.

### SUMMARY

Embodiments of the present disclosure provide a method, an apparatus, a device, a medium and a product for processing a layout of a media stream.

According to a first aspect of the present disclosure, there is provided a method for processing a layout of a media stream. The method includes sending, from a client to a server, a request associated with a live streaming to receive, from the server, a layout identification corresponding to a target layout of a set of media streams of a set of users in the live streaming. The method further includes in response to there being a set of configuration template files for a layout of a media stream of the live streaming at the client, determining, based on the layout identification, whether the set of configuration template files include the target layout. The method further includes in response to the target layout not being included in the set of configuration template files, sending a template acquisition request to the server to receive, from the server, a target configuration template file including the layout identification, the template acquisition request including the layout identification. The method further includes displaying, based on the target configuration template file, the set of media streams of the set of users in the live streaming using the target layout corresponding to the layout identification.

According to a second aspect of the present disclosure, there is provided a method for processing a layout of a media stream. The method includes in response to receiving, at a server, a request associated with a live streaming from a client, sending, to the client, a layout identification corresponding to a target layout of a set of media streams of a set of users in the live streaming. The method further includes in response to the target layout corresponding to the layout identification not being included in a set of configuration template files of the client for a layout of a media stream of the live streaming, receiving, from the client, a template acquisition request, the template acquisition request including the layout identification. The method further includes searching for a target configuration template file including the layout identification from a plurality of configuration template files. The method further includes sending the target configuration template file to the client for displaying the set of media streams of the set of users in the live streaming.

According to a third aspect of the present disclosure, there is provided an apparatus for processing a layout of a media stream. The apparatus includes a join layout identification receiving module configured to send, from a client to a server, a request associated with a live streaming to receive, from the server, a layout identification corresponding to a target layout of a set of media streams of a set of users in the live streaming; a template matching module configured to, in response to there being a set of configuration template files for a layout of a media stream of the live streaming at the client, determine, based on the layout identification, whether the set of configuration template files include the target layout; a template acquisition module configured to, in response to the target layout not being included in the set of configuration template files, send a template acquisition request to the server to receive, from the server, a target configuration template file including the layout identification, the template acquisition request including the layout identification; and a layout display module configured to, based on the target configuration template file, display the set of media streams of the set of users in the live streaming using the target layout corresponding to the layout identification.

According to a fourth aspect of the present disclosure, there is provided an apparatus for processing a layout of a media stream. The apparatus includes a layout identification sending module configured to, in response to receiving, at a server, a request associated with a live streaming from a client, send, to the client, a layout identification corresponding to a target layout of a set of media streams of a set of users in the live streaming; a template acquisition request receiving module configured to, in response to the target layout corresponding to the layout identification not being included in a set of configuration template files of the client for a layout of a media stream of the live streaming, receive, from the client, a template acquisition request, the template acquisition request including the layout identification; a searching module configured to search for a target configuration template file including the layout identification from a plurality of configuration template files; and a configuration template file sending module configured to send the target configuration template file to the client for displaying the set of media streams of the set of users in the live streaming.

In a fifth aspect of the present disclosure, there is provided an electronic device, including at least one processor; and a storage apparatus, configured to store at least one program, where the at least one program, when executed by the at least one processor, causes the at least one processor to implement the methods according to the first aspect and second aspect of the present disclosure.

In a sixth aspect of the present disclosure, there is provided a computer-readable storage medium having a computer program stored thereon, where the program, when executed by a processor, implements the methods according to the first aspect and second aspect of the present disclosure.

In a seventh aspect of the present disclosure, there is provided a computer program product. The computer program product includes a computer program, where the computer program, when executed by a processor, implements the methods according to the first aspect and second aspect of the present disclosure.

It should be understood that the content described in this section is not intended to identify key or important features of the embodiments of the present disclosure, nor is it intended to limit the scope of the present disclosure. Other features of the present disclosure will become readily understood through the following description.

### BRIEF DESCRIPTION OF THE DRAWINGS

The above and other objects, features and advantages of the present disclosure will become more apparent by describing the exemplary embodiments of the present disclosure in more detail in conjunction with the drawings, in which the same reference numerals generally represent the same components in the exemplary embodiments of the present disclosure.

FIG. 1 illustrates a schematic diagram of an example environment in which a device and/or a method of some embodiments of the present disclosure may be implemented;

FIG. 2 illustrates a schematic diagram of an example method for processing a layout of a media stream according to some embodiments of the present disclosure;

FIG. 3 illustrates a schematic diagram of another example method for processing a layout of a media stream according to some embodiments of the present disclosure;

FIG. 4 illustrates a schematic diagram of an example method for performing a layout of a media stream according to some embodiments of the present disclosure;

FIG. 5 illustrates a schematic diagram of different layouts of four users co-hosting according to some embodiments of the present disclosure;

FIG. 6 illustrates a schematic diagram of different layouts of six users co-hosting according to some embodiments of the present disclosure;

FIG. 7 illustrates a schematic diagram of different layouts of nine users co-hosting according to some embodiments of the present disclosure;

FIG. 8 illustrates a schematic diagram of an example for dynamically adjusting a layout according to some embodiments of the present disclosure;

FIG. 9 illustrates a schematic block diagram of an apparatus for processing a layout of a media stream according to some embodiments of the present disclosure;

FIG. 10 illustrates a schematic block diagram of another apparatus for processing a layout of a media stream according to some embodiments of the present disclosure;

FIG. 11 illustrates a schematic block diagram of an example device suitable for implementing multiple embodiments of the present disclosure.

### DETAILED DESCRIPTION OF EMBODIMENTS

It may be understood that the data involved in the technical solution (including but not limited to the data itself, acquisition or use of the data) shall comply with requirements of corresponding laws, regulations, and related provisions.

It may be understood that before the use of the technical solutions disclosed in embodiments of the present disclosure, users shall be informed of the type, range of use, use scenarios, etc., of personal information involved in the present disclosure and the authorization of the users shall be obtained in an appropriate manner in accordance with related laws and regulations.

For example, when an active request of a user is received, prompt information is sent to the user to clearly inform the user that the requested operation will require access to and use of personal information of the user. As such, enabling the user independently choose, based on the prompt information, whether to provide the personal information to software or hardware, such as an electronic device, an application, a server or a storage medium, that performs operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose "agree" or "disagree" to provide the personal information to the electronic device.

It may be understood that the above process of notifying the user and acquiring the authorization of the user is only illustrative and does not limit the implementations of the present disclosure, and other manners that satisfy the related laws and regulations may also be applied in the implementations of the present disclosure.

Hereinafter, embodiments of the present disclosure will be described in more detail with reference to the drawings. Although some embodiments of the present disclosure are shown in the drawings, it should be understood that the present disclosure may be implemented in various forms and should not be construed as limited to the embodiments set forth herein. Rather, these embodiments are provided for a thorough and complete understanding of the present disclosure. It should be understood that the drawings and embodiments of the present disclosure are only for the purpose of illustration, and are not intended to limit the protection scope of the present disclosure.

In the description of the embodiments of the present disclosure, the term "include/comprise" and similar terms should be understood as open-ended inclusions, that is, "include/comprise but not limited to". The term "based on" should be understood as "based at least in part on". The term "one embodiment" or "the embodiment" should be understood as "at least one embodiment". The terms "first", "second", etc. may refer to different or same objects. Other definitions, either explicit or implicit, may also be included below.

As mentioned above, with the rapid development of mobile Internet and the live streaming industry, various social live streaming platforms, online conference software and online learning software have an increasing demand for co-hosting interaction. At present, live streaming platforms allow multiple users to co-host at the same time and provide diverse video layouts to enhance user interaction experience. In scenarios such as social entertainment, remote office, and online classes, a reasonable co-hosting layout may optimize the user's viewing experience and make the presented content clearer. At the same time, with the development of technologies such as cloud computing, these technologies provide stronger computing power for dynamic adjustment of audio and video layout, enabling smoother rendering and presentation of multi-user video pictures between different terminal devices.

Generally, in the existing live streaming co-hosting solutions, although a wide range of video layout pictures may be presented, there are still certain limitations. For example, in the existing co-hosting layout solutions, the maximum number of co-hosts and the co-hosting layout style are fixed. When the maximum number of co-hosts or the co-hosting layout style needs to be changed, the code needs to be modified again and the user needs to upgrade to a new client, which not only increases the development cost and maintenance cost, but also affects the user experience.

To this end, an embodiment of the present disclosure provides a method for processing a layout of a media stream. In this method, a request associated with a live streaming is sent from a client to a server to receive, from the server, a layout identification corresponding to a target layout of a set of media streams of a set of users in the live streaming. If there is a set of configuration template files for the layout of the media stream of the live streaming in the client, the layout identification further needs to be used to determine whether the set of configuration template files includes the target layout. If the target layout is not included in the set of configuration template files, the client needs to send a template acquisition request to the server to receive a target configuration template file including the layout identification from the server, where the template acquisition request includes the layout identification. Finally, the client may use the target layout corresponding to the layout identification in the target configuration template file to display the set of media streams of the set of users in the live streaming. Through this method, the co-hosting layout display of the client is implemented using the layout and layout identification in the configuration template file, so that the client only needs to download the configuration template file to implement layout update, quickly adapt to requirements of different scenarios, and improve the user experience.

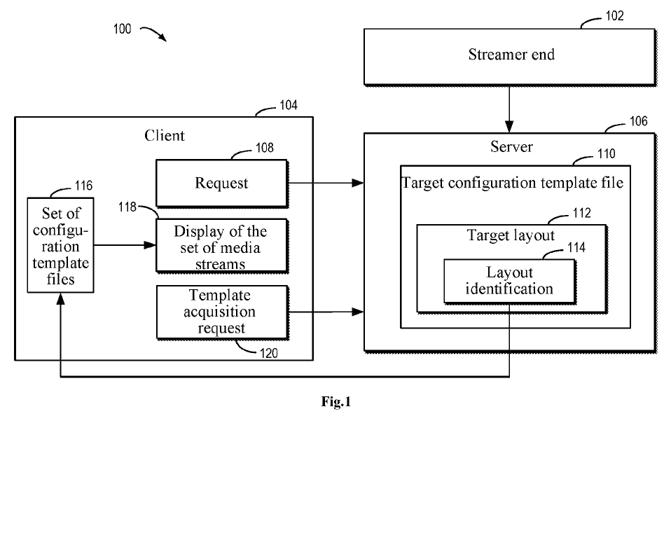

Hereinafter, embodiments of the present disclosure will be described in detail in conjunction with the drawings. FIG. 1 illustrates an example environment in which a device and/or a method of the embodiments of the present disclosure may be implemented. The environment 100 includes a streamer end 102, a client 104 and a server 106.

Examples of the streamer end 102, the client 104 and the server 106 include, but are not limited to, personal computers, server computers, handheld or laptop devices, mobile devices (such as mobile phones, personal digital assistants (PDAs), media players, etc.), multi-processor systems, consumer electronic products, minicomputers, mainframe computers, distributed computing environments including any of the above systems or devices, etc.

As shown in FIG. 1, in a live streaming scenario, the streamer end 102 may start a live streaming and establish a co-hosting chat with other users. When a streamer starts a multi-user chat through the streamer end 102, a layout parameter corresponding to co-hosting users of the live streaming may be selected in a live streaming application, such as a layout style to be used and a maximum number of users participating in the chat of the live streaming. For example, the streamer may select a co-hosting layout in a grid style with a maximum number of 8. After the streamer end 102 provides the above parameters to the server 106, the server 106 may select a corresponding layout for these parameters and determine a layout identification 114 of the layout. For the convenience of description, this layout may be referred to as a first layout, and the layout identification 114 may also be referred to as a first layout identification. The server 106 may associatively store an identification of the live streaming and the corresponding layout identification 114. For example, the live streaming is performed in a live room, and the identification of the live streaming is an identification of the live room.

When acquiring a live streaming through the client 104, for example, an audience or a guest may send a request 108 associated with the live streaming to the server 106. Then, the client 104 may acquire the layout identification 114 for the live streaming from the server 106. For example, the client 104 may send the identification of the live streaming to the server 106 to acquire the layout identification 114 from the server 106.

In a traditional client, a live streaming layout is fixed in the client, and the client 104 may only use the fixed layout to display a co-hosting user's video stream layout. In the present disclosure, however, the client 104 does not fix a layout in an application, but may download a set of configuration template files 116, which includes different layouts. Therefore, the client 104 may determine a live streaming layout by using the set of configuration template files 116 in combination with the layout identification 114 acquired from the server 106. The set of configuration template files 116 may include one configuration template file or multiple configuration template files. In one example, the set of configuration template files are loaded from the server when the live streaming application is cold started. In another example, the set of configuration template files are loaded from the server when the application is previously used. The above examples are only used to describe the present disclosure, rather than limiting the present disclosure.

In addition, in order to adapt to the rapid change of user requirements for live streaming, developers usually provide many new co-hosting layouts on the server 106 for users to use. Therefore, the server 106 may provide a new layout parameter to the streamer end for the streamer to select. At this time, if the streamer end 102 selects the new layout parameter, the layout corresponding to the new layout parameter may not exist in the set of configuration template files of the client. If the streamer end 102 selects an old layout parameter, the layout corresponding to this layout parameter may exist in the set of template configuration files of the client. In order to accurately display the co-hosting layout, the client now needs to match the layout identification 114 with layout identifications in the set of configuration template files 116 after acquiring the layout identification 114. If the layout identification is found, the first layout corresponding to the layout identification is acquired from the set of configuration template files 116 to display 118 the set of media streams on the client 104.

If the layout identification 114 is a new layout identification to the client 104, the layout identification will not be found in the set of configuration files of the client 104. At this time, the client 104 needs to generate a template acquisition request 120 including the layout identification 114 and send it to the server 106. After receiving the template acquisition request 120, the server 106 will search for the target configuration template file 110 including the layout identification among multiple configuration template files stored in the server. Then, the server 106 sends the target configuration template file 110 to the client 104, so that the client 104 may re-parse the target layout 112 to be used according to the target configuration template file. Then, the set of media streams are displayed using the target layout.

For the live streaming scenario, if the target layout cannot be changed after initial setup, the user experience will deteriorate when the co-hosting users change or user requirements change later. For example, if a user initially sets the maximum number of co-hosting users to 4, but when the streamer finds that the number of users joining the co-hosting is much larger than the initially set number, this will prevent other users from joining. In order to further change this situation, in the present disclosure, the co-hosting layout is further set to be dynamically adjustable in real time. For example, if a grid layout is initially set with a maximum number of co-hosts of 4, a panel layout may be set with a maximum number of co-hosts of 9 due to an increase of users, thereby dynamically adjusting the co-hosting layout. Therefore, it is necessary to continue to provide layout parameter selection options for the streamer during the live streaming. If the streamer adjusts the corresponding layout parameter, the server 106 may determine the layout identification corresponding to the layout parameter after receiving the adjustment of the layout parameter. Then, the layout identification is sent to the client in real time, and the client 104 may further detect the set of configuration template files and/or the newly downloaded layout configuration file to adjust the layout.

In addition, because the set of configuration template files are used in the present disclosure, it is necessary to load a configuration template file parsing engine on the client. Both the set of configuration template files acquired by the client 104 from the server 106 and the newly downloaded configuration template file need to be parsed by this parsing engine.

Because software applications are installed on the client at different times, an earlier installed version may not have the parsing engine for the configuration template file installed. In this case, even if the client receives the layout identification, the available configuration template file cannot be acquired due to the absence of the configuration template file parsing engine in the client. In order to solve this problem, the client 104 may further send a request for acquiring the parsing engine to the server 106, and the server 106 will acquire the parsing engine after receiving the request. In addition, the server 106 also acquires the configuration template file corresponding to the layout identification. Then, the parsing engine and the configuration template file are sent to the client 104 together. Next, the client 104 installs the parsing engine, and uses the parsing engine to parse the configuration template file to acquire the corresponding target layout to display the co-hosting user's video stream layout. Alternatively, the client 104 and the streamer end 102 shown in FIG. 1 may be the same device, that is, the streamer end may be used as the client.

Through this method, the co-hosting layout display of the client is implemented using the layout and layout identification in the configuration template file, so that the client only needs to download the configuration template file to implement layout adjustment, quickly adapt to requirements of different scenarios, and improve the user experience. Furthermore, the layout may be further dynamically adjusted, thereby improving the user experience.

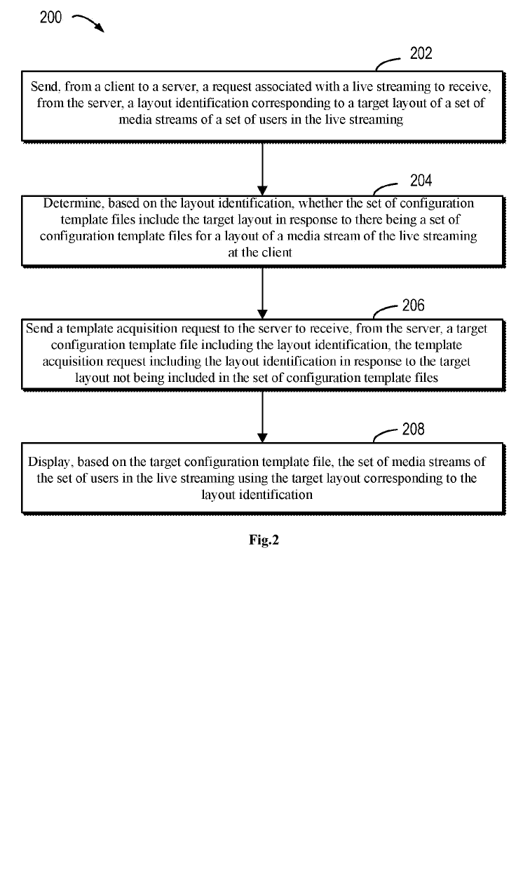

The schematic diagram of the example environment in which the device and/or method of some embodiments of the present disclosure may be implemented is described above in conjunction with FIG. 1, and the schematic diagram of the example method for processing the layout of the media stream according to some embodiments of the present disclosure is described below in conjunction with FIG. 2. The method in FIG. 2 may be performed by the client 104 in FIG. 1 or any suitable computing device.

As shown in FIG. 2, in the example method 200, at block 202, a request associated with a live streaming is sent from a client 104 to a server 106 to receive, from the server, a layout identification corresponding to a target layout of a set of media streams of a set of users in the live streaming. When a user wants to acquire the live streaming, the user may acquire the layout identification from the server 106. For example, when the user wants to watch the live streaming or participate in the live streaming, the user may acquire the layout identification from the server. The layout identification is determined based on a layout style received from a streamer end of the live streaming and a maximum number of users participating in a chat of the live streaming. Alternatively, the client 104 may be the streamer end, and therefore, the join request at this time also includes the layout style and the maximum number of users participating in the chat of the live streaming.

At block 204, in response to there being a set of configuration template files for a layout of a media stream of the live streaming at the client, the client 104 determines, based on the layout identification, whether the set of configuration template files include the target layout. When there are configuration template files at the client, the client 104 may check whether multiple layout identifications in the set of configuration template files include the layout identification of the live room received from the server. If the layout identification does not exist among the multiple layout identifications, the client 104 may determine that the target layout is not included in the set of configuration template files.

At block 206, in response to the target layout not being included in the set of configuration template files, the client 104 sends a template acquisition request to the server 106 to receive, from the server, a target configuration template file including the layout identification, the template acquisition request including the layout identification. At this time, in order to be able to acquire the layout corresponding to the layout identification, the client 104 will further request the target configuration template file including the layout identification from the server 106.

At block 208, the client 104 displays, based on the target configuration template file, the set of media streams of the set of users in the live streaming using the target layout corresponding to the layout identification. After acquiring the target configuration template file 110, the client 104 may acquire the target layout corresponding to the layout identification therefrom, and then may use the target layout to display the set of media streams of the set of co-hosting users. For the convenience of description, this layout identification may be referred to as a first layout identification, and the target layout may be referred to as a first layout.

In some embodiments, for example, if the streamer end adjusts the target layout during the live streaming, the client 104 will receive a second layout identification corresponding to the adjusted target layout from the server 106. Then, the client 104 may determine whether the set of configuration template files and the target configuration template file include the second layout identification. If the set of configuration template files and the target configuration template file include the second layout identification, a second layout corresponding to the second layout identification may be acquired from the set of configuration template files and the target configuration template file. Then, the second layout is used to adjust the display of the set of media streams of the set of users in the live streaming. For the convenience of description, the aforementioned template acquisition request is a first template acquisition request, and the target configuration template file is referred to as a first configuration template file.

In addition, if the set of configuration template files and the first configuration template file do not include the second layout identification, it indicates that there is no second layout corresponding to the second layout identification in the client. At this time, the client 104 needs to send a second template acquisition request to the server 106 to receive a second configuration template file including the second layout identification from the server 106, where the second template acquisition request includes the second layout identification. After the client 104 acquires the second configuration template file from the server 106, the second layout in the second configuration template file is used to adjust the display of the set of media streams of the set of users in the live streaming.

If during the previous detection process, the client 104 detects that the layout identification is included in a third configuration template file in the set of configuration template files, the client 104 may acquire the target layout corresponding to the layout identification from the third configuration template file. Then, the client 104 further uses the target layout to display the set of media streams of the set of users in the live streaming.

In some embodiments, when displaying the set of media streams of the set of users in the live streaming using the target layout corresponding to the layout identification, a local parsing engine first needs to be used to parse the newly acquired target configuration template file. Then, the client 104 display the set of media streams of the set of users in the live streaming using the target layout corresponding to the layout identification in the parsed target configuration template file . In addition, the set of configuration template files stored in the client 104 are loaded when the application is cold started and parsed by the parsing engine.

Alternatively, if there is no configuration template file for the layout of the media stream of the live streaming at the client, it indicates that a parsing engine available for parsing the configuration template file is not present at the client. At this time, the client 104 may send an acquisition request for acquiring the parsing engine to the server 106. Then, the client 104 may receive the parsing engine and a fourth configuration template file including the layout identification from the server 106. Thus, the client may parse the fourth configuration template file using the parsing engine to acquire the target layout corresponding to the layout identification.

Through this method, the co-hosting layout display of the client is implemented using the layout and layout identification in the configuration template file, so that the client only needs to download the configuration template file to implement layout adjustment, quickly adapt to requirements of different scenarios, and improve the user experience. Furthermore, the layout may be further dynamically adjusted, thereby improving the user experience.

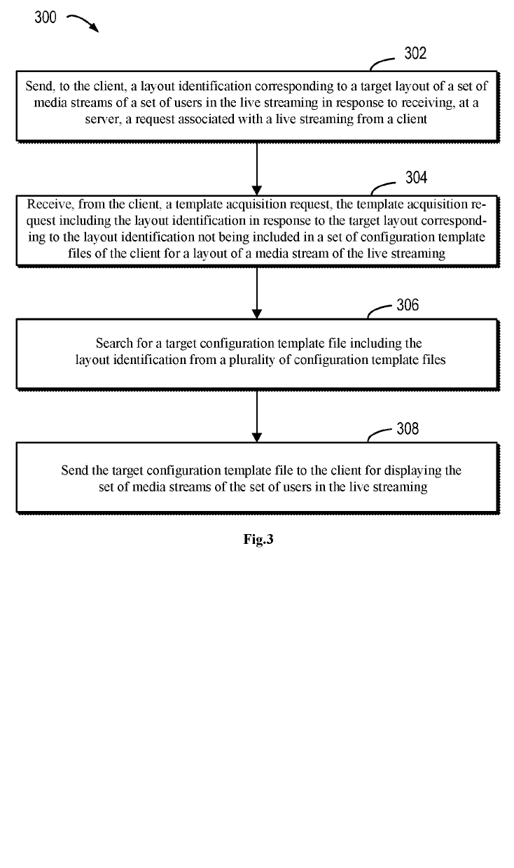

The schematic diagram of the example method for processing the layout of the media stream according to some embodiments of the present disclosure is described above in conjunction with FIG. 2, and the schematic diagram of another example method for processing the layout of the media stream according to some embodiments of the present disclosure is described below in conjunction with FIG. 3. The example method 300 in FIG. 3 may be performed by the server 106 in FIG. 1 or any suitable computing device.

At block 302, in response to receiving, at a server, a request associated with a live streaming from a client, a layout identification corresponding to a target layout of a set of media streams of a set of users in the live streaming is sent to the client. If the server 106 receives a join request from the client 104, the layout identification of the live room is sent to the client 104.

At block 304, in response to the target layout corresponding to the layout identification not being included in a set of configuration template files of the client for a layout of a media stream of the live streaming, the server 106 receives, from the client, a template acquisition request, the template acquisition request including the layout identification. If the layout corresponding to the layout identification received from the server 106 cannot be found in the client 104, the server 106 may further receive a request for acquiring the configuration template file from the client.

At block 306, the server 106 searches for a target configuration template file including the layout identification from a plurality of configuration template files. If the server 106 receives the template acquisition request, it will search for the target configuration template file having the layout identification from the plurality of configuration template files already stored in the server 106. Then, at block 308, the server 106 sends the target configuration template file to the client for displaying the set of media streams of the set of users in the live streaming.

In some embodiments, when starting to establish a live streaming, the server 106 may receive a selection of layout parameters from a streamer end of the live streaming, such as a layout style and a maximum number of users participating in a chat of the live streaming. Then, the server 106 may determine the layout identification according to the received layout parameters.

Further, if an adjusted layout parameter is received from the streamer end during the live streaming, for example, at least one of an adjusted layout style and an adjusted maximum number, the server 106 may determine a second layout identification corresponding to the adjusted target layout. Then, the server 106 sends the second layout identification to the client 104 for displaying the set of media streams of the set of users in the live streaming.

In addition, the server 106 may also receive a second template acquisition request from the client when the set of configuration template files and the first configuration template file do not include the second layout identification, the second template acquisition request including the second layout identification. Then, the server 106 further selects a second configuration template file corresponding to the second layout identification from the plurality of configuration template files. Next, the server 106 sends the second configuration template file including the second layout identification to the client to adjust the display of the set of media streams of the set of users in the live streaming using the second layout corresponding to the second layout identification.

Further, if there is no configuration template file for the layout of the media stream of the live streaming at the client, the server 106 may receive an acquisition request for acquiring the parsing engine from the client 104. Then, the server 106 sends the parsing engine and a fourth configuration template file including the layout identification to the client to acquire the target layout corresponding to the layout identification using the parsing engine.

Through this method, the co-hosting layout display of the client is implemented using the layout and layout identification in the configuration template file, so that the server only needs to send the configuration template file to implement layout adjustment, quickly adapt to requirements of different scenarios, and improve the user experience. Furthermore, the layout may be further dynamically adjusted, thereby improving the user experience.

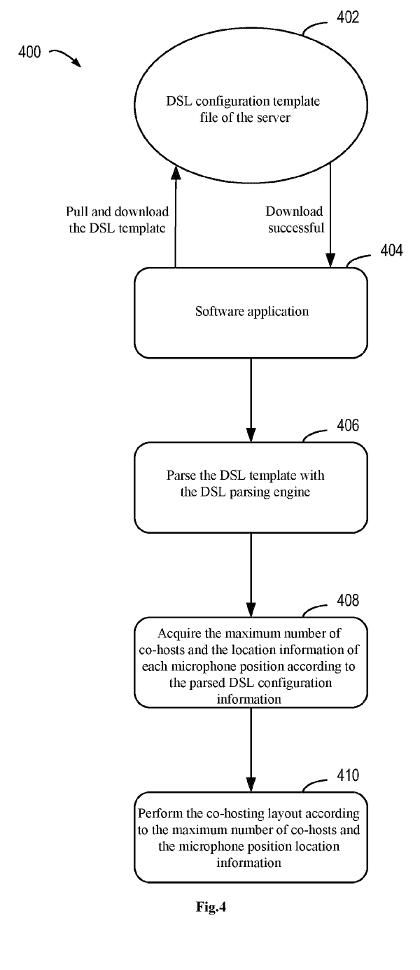

The schematic diagram of the example method for processing the layout of the media stream according to some embodiments of the present disclosure is described above in conjunction with FIG. 3. The schematic diagram of the example method for performing the layout of the media stream according to some embodiments of the present disclosure is described below in conjunction with FIG. 4. The example method 400 in FIG. 4 may be performed by the client 104 shown in FIG. 1 or any suitable computing device.

The co-hosting layout processing flow based on a domain specific language (DSL) configuration template is described in the example method 400. First, at block 402, a server maintains a latest DSL configuration template file, where the DSL configuration template file may be used to define rules of the co-hosting layout. When a client lacks a configuration template file for the media stream layout of the live streaming or needs to update a local configuration template file, the client initiates a request to the server to pull the latest DSL template. The server may be a cloud server.

The DSL configuration template file is used to describe microphone position information (number of microphone positions, microphone position location information).

At block 404, when a software application of the client is started, the client requests to download the DSL configuration template file from the server. After the cloud server successfully returns the DSL template, the client stores and parses the DSL template. At block 406, the client calls a DSL parsing engine to parse the downloaded DSL template. During the parsing process, the system reads key information such as the co-hosting layout rules defined in the DSL template, the maximum number of co-hosts and the location of each co-hosting user.

Finally, at block 408, according to the parsed DSL configuration information, the client may acquire the maximum number of co-hosts and location information for a layout according to a layout identification of a user joining the live streaming. At block 410, the client performs the co-hosting layout according to the maximum number of co-hosts and the microphone position location information. This layout may adapt to different live streaming scenarios, and the layout is one of multiple preset layouts selected by the streamer end, such as a grid uniform distribution layout or a non-uniform distribution layout.

Through this method, the server DSL template configuration, client parsing and dynamic layout adjustment are adopted to implement more flexible and efficient layout management, which provides better user experience and technical support for other scenarios that require co-hosting, such as live streaming and video conferences.

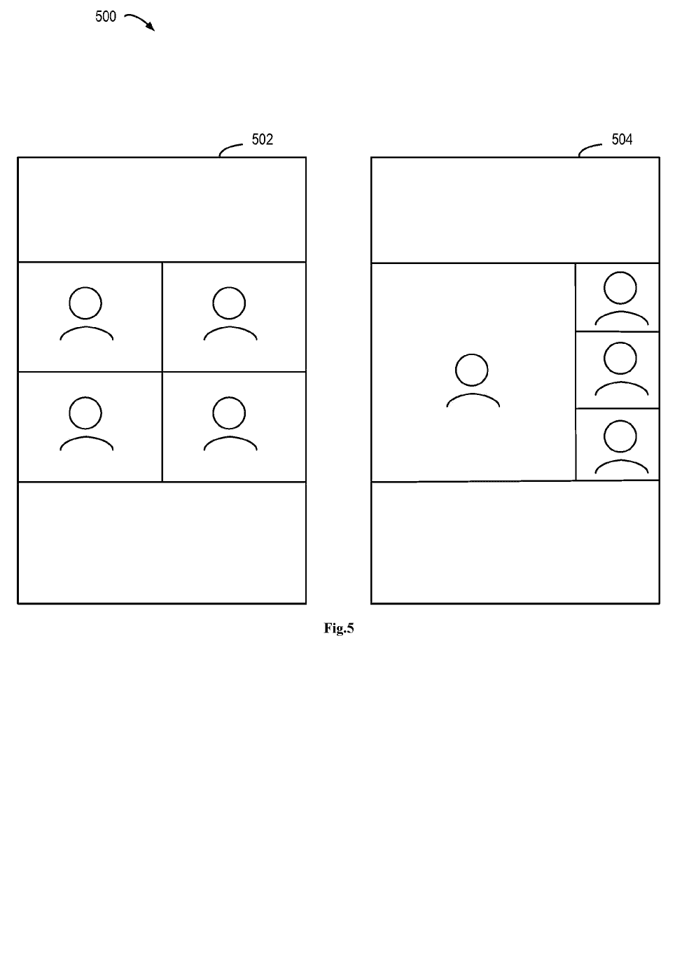

The schematic diagram of the example method of the technical solution for processing the layout of the media stream according to some embodiments of the present disclosure is described above in conjunction with FIG. 4, and the schematic diagram of different layouts of four users co-hosting according to some embodiments of the present disclosure is described below in conjunction with FIG. 5.

In example 500, the co-hosting style of example 502 may support up to four users to co-host, and a grid uniform distribution style is adopted. When there are less than four co-hosting users, the users on the microphone positions will equally divide and occupy the area of the co-hosting display area. When there are four co-hosting users, the four users will equally divide and occupy the area of the co-hosting display area, and at this time, the microphone position of each user presents a square shape. If there is another user who also applies to co-host at this time, the user will enter a waiting queue until a microphone position is vacant and the streamer end's consent is obtained before entering the microphone position. Example 504 shows a four-user co-hosting style in a non-uniform distribution style, such as a panel style. At this time, the streamer's microphone position occupies a larger area on the left, while the users on the microphone equally divide a small vertical bar area on the right.

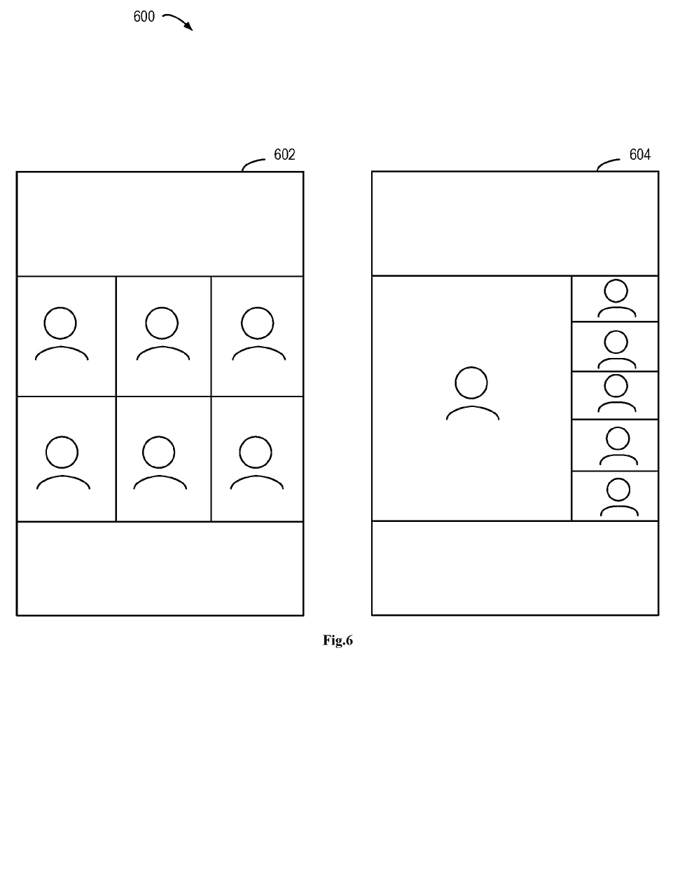

The schematic diagram of different layouts of four users co-hosting according to some embodiments of the present disclosure is described above in conjunction with FIG. 5, and the schematic diagram of different layouts of six users co-hosting according to some embodiments of the present disclosure is described below in conjunction with FIG. 6.

In example 600, the co-hosting style of example 602 may support up to six users to co-host, and a grid uniform distribution style is adopted. When the number of users on the field is less than or equal to six, all the microphone positions on the field equally divide the area of the co-hosting display area. Example 604 shows a six-user co-hosting style in a non-uniform distribution style. At this time, the streamer's microphone position occupies a larger area on the left, while the users on the microphone equally divide a small vertical bar area on the right.

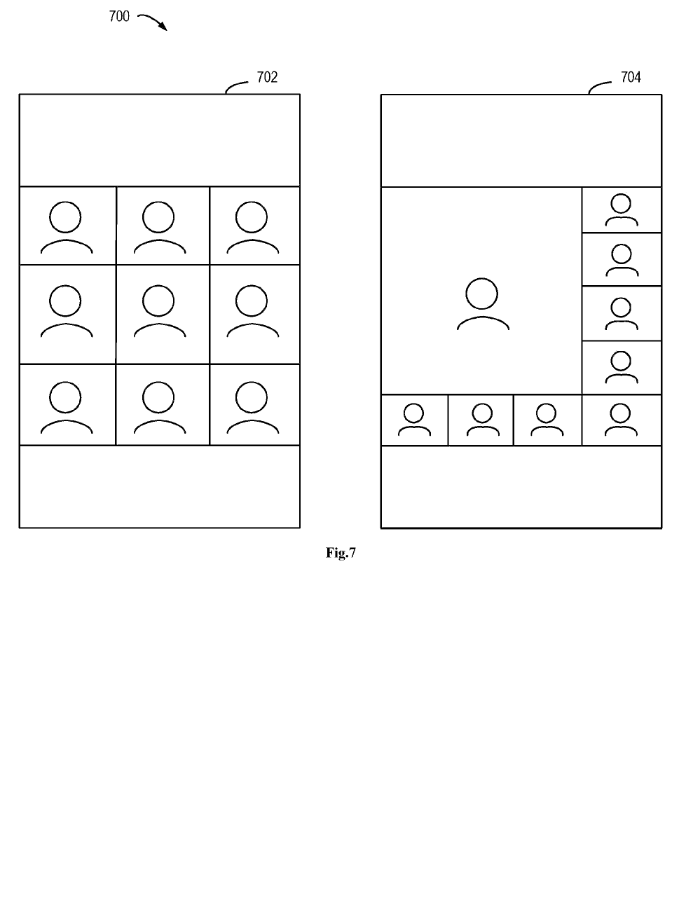

The schematic diagram of different layouts of six users co-hosting according to some embodiments of the present disclosure is described above in conjunction with FIG. 6, and the schematic diagram of different layouts of nine users co-hosting according to some embodiments of the present disclosure is described below in conjunction with FIG. 7.

In example 700, the co-hosting style of example 702 may support up to nine users to co-host, and a grid uniform distribution style is adopted. When the number of users on the field is less than or equal to nine, all the microphone positions on the field equally divide the area of the co-hosting display area. Example 704 shows a nine-user co-hosting style in a non-uniform distribution style. At this time, the streamer's microphone position occupies a larger area in the upper left corner, and other people occupy other co-hosting display areas except the streamer's area, presenting a form where the streamer is in the upper left corner and the remaining microphones surround the streamer.

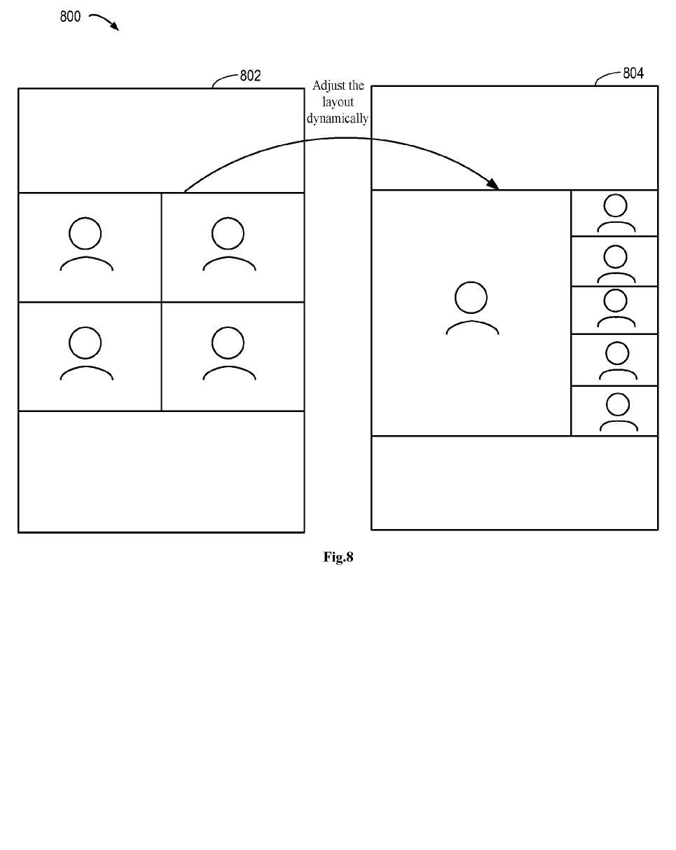

The schematic diagram of different layouts of six users co-hosting according to some embodiments of the present disclosure is described above in conjunction with FIG. 7, and the schematic diagram of an example for dynamically adjusting a layout according to some embodiments of the present disclosure is described below in conjunction with FIG. 8.

In example 800, the adjustment of the layout of four users co-hosting is taken as an example. When the number of people the streamer wants to join the live streaming co-hosting increases during the live streaming, and the streamer wants to change the display layout 802, the streamer end will re-select the layout parameters, such as the layout style and the maximum number of users participating in the chat. After the streamer end changes the layout style from the original grid uniform distribution style to the non-uniform distribution style and increases the maximum number of users, the server will send a layout identification corresponding to this non-uniform distribution style to the client. After receiving the layout identification, the client first determines whether the new layout may be found. If the layout is found in the configuration template text of the client, the layout at this time is dynamically adjusted. If the layout is not found in the configuration template text of the client, a request will be sent to the server to acquire a new configuration template file to load the layout. After being displayed in the new layout, as shown in layout 804, the area of the streamer's microphone position is increased, and the users of the other five microphone positions are distributed in the vertical bar space on the right side of the streamer after preset adjustment, and the area occupied by the five microphone positions equally divides the area of the vertical bar space on the right side.

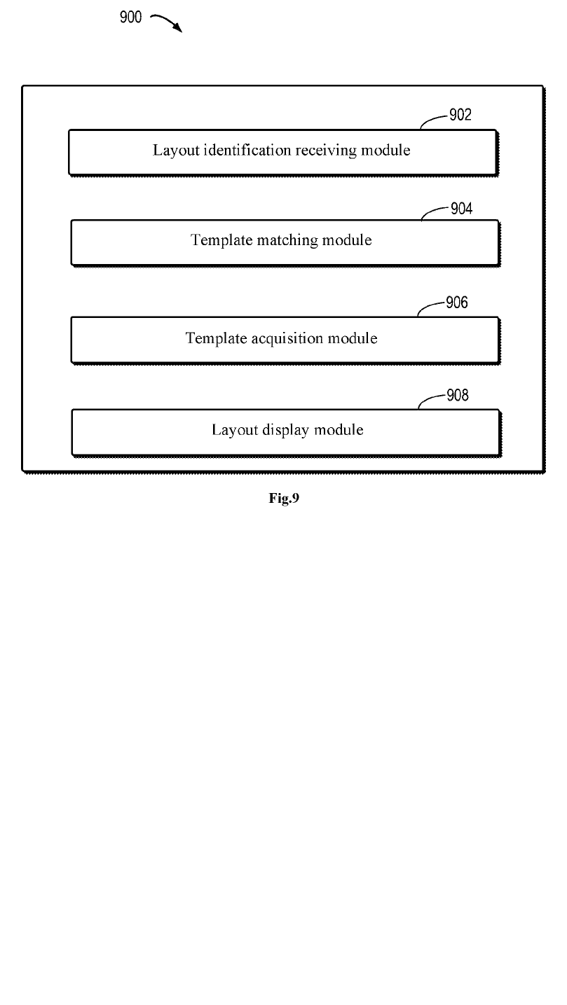

FIG. 9 illustrates a schematic block diagram of an apparatus for processing a layout of a media stream according to some embodiments of the present disclosure. As shown in FIG. 9, the apparatus 900 includes a layout identification receiving module 902 configured to send, from a client to a server, a request associated with a live streaming to receive, from the server, a layout identification corresponding to a target layout of a set of media streams of a set of users in the live streaming; a template matching module 904 configured to, in response to there being a set of configuration template files for a layout of a media stream of the live streaming at the client, determine, based on the layout identification, whether the set of configuration template files include the target layout; a template acquisition module 906 configured to, in response to the target layout not being included in the set of configuration template files, send a template acquisition request to the server to receive, from the server, a target configuration template file including the layout identification, the template acquisition request including the layout identification; and a layout display module 908 configured to, based on the target configuration template file, display the set of media streams of the set of users in the live streaming using the target layout corresponding to the layout identification.

In some embodiments, the layout identification is determined based on a layout style received from a streamer end of the live streaming and a maximum number of users participating in a chat of the live streaming.

In some embodiments, the layout identification is a first layout identification, the target layout is a first layout, and the apparatus 900 further includes: a second layout identification receiving module configured to, in response to the target layout being adjusted by the streamer end during the live streaming, receive a second layout identification corresponding to the adjusted target layout; a second layout acquisition module configured to, in response to the second layout identification being included in the set of configuration template files and the target configuration template file, acquire a second layout corresponding to the second layout identification from the set of configuration template files and the target configuration template file; and a first adjustment module configured to adjust the display of the set of media streams of the set of users in the live streaming using the second layout.

In some embodiments, the template acquisition request is a first template acquisition request, and the target configuration template file is a first configuration template file, the apparatus 900 further includes: a second template acquisition request sending module configured to, in response to the second layout identification not being included in the set of configuration template files and the first configuration template file, send a second template acquisition request to the server to receive a second configuration template file including the second layout identification from the server, the second template acquisition request including the second layout identification; and a second adjustment module configured to adjust the display of the set of media streams of the set of users in the live streaming based on the second layout in the second configuration template file.

In some embodiments, the apparatus 900 further includes: a target layout acquisition module configured to, in response to the layout identification being included in a third configuration template file in the set of configuration template files, acquire the target layout corresponding to the layout identification from the third configuration template file; and a first media stream display module configured to display the set of media streams of the set of users in the live streaming using the target layout.

In some embodiments, the layout display module 908 includes: a parsing module configured to parse the target configuration template file using a local parsing engine; and a second media stream display module configured to display the set of media streams of the set of users in the live streaming using the target layout corresponding to the layout identification in the parsed target configuration template file.

In some embodiments, the template matching module 904 includes: a layout identification existence determination module configured to determine whether the layout identification exists among multiple layout identifications in the set of configuration template files; and a result determination module configured to, in response to the layout identification not existing among the multiple layout identifications, determine that the target layout is not included in the set of configuration template files.

In some embodiments, the apparatus 900 further includes: a parsing engine determination module configured to, in response to there being no configuration template file for the layout of the media stream of the live streaming at the client, determine that a parsing engine available for parsing the configuration template file is not present at the client, in response to a configuration template file for the layout of the media stream of the live streaming not being present at the client; an acquisition request sending module configured to send an acquisition request for acquiring the parsing engine to the server; a fourth configuration template file receiving module configured to receive the parsing engine and a fourth configuration template file including the layout identification from the server; and a second target layout acquisition module configured to parse the fourth configuration template file using the parsing engine to acquire the target layout corresponding to the layout identification.

In some embodiments, the template configuration file includes a layout style, a maximum number of users participating in a chat of the live streaming, and a display position of a video stream for each user.

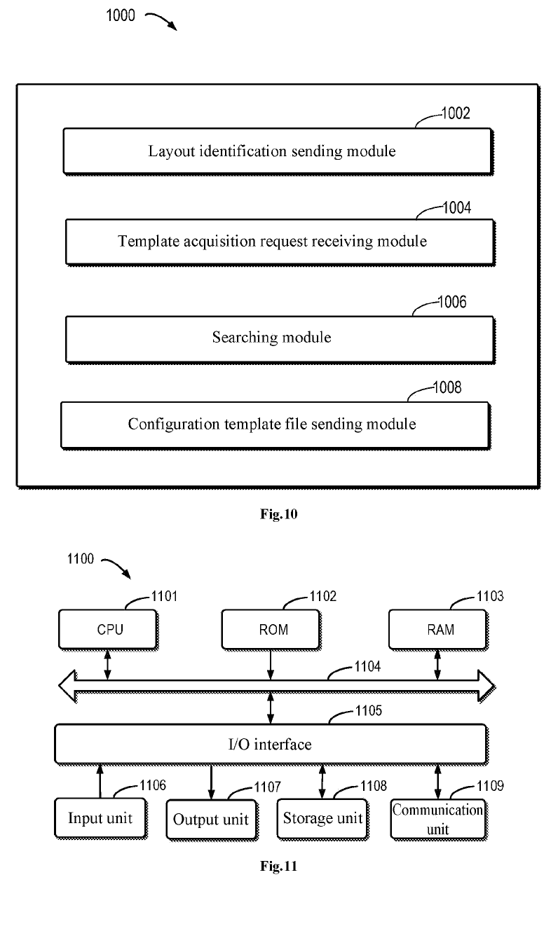

FIG. 10 illustrates a schematic block diagram of another apparatus for processing a layout of a media stream according to some embodiments of the present disclosure. As shown in FIG. 10, the apparatus 1000 includes a layout identification sending module 1002 configured to, in response to receiving, at a server, a request associated with a live streaming from a client, send a layout identification corresponding to a target layout of a set of media streams of a set of users in the live streaming to the client; a template acquisition request receiving module 1004 configured to, in response to the target layout corresponding to the layout identification not being included in a set of configuration template files of the client for a layout of a media stream of the live streaming, receive a template acquisition request from the client, the template acquisition request including the layout identification; a searching module 1006 configured to search for a target configuration template file including the layout identification from a plurality of configuration template files; and a configuration template file sending module 1008 configured to send the target configuration template file to the client for displaying the set of media streams of the set of users in the live streaming.

In some embodiments, the apparatus 1000 further includes: a style and number receiving module configured to receive a layout style and a maximum number of users participating in a chat of the live streaming from a streamer end of the live streaming; and a layout identification determination module configured to determine the layout identification based on the layout style and the maximum number.

In some embodiments, the layout identification is a first layout identification, the target layout is a first layout, and the apparatus 1000 further includes: a second layout identification determination module configured to, in response to receiving at least one of an adjusted layout style and an adjusted maximum number from the streamer end during the live streaming, determine a second layout identification corresponding to the adjusted target layout; and a second layout identification sending module configured to send the second layout identification to the client for displaying the set of media streams of the set of users in the live streaming.

In some embodiments, the template acquisition request is a first template acquisition request, and the target configuration template file is a first configuration template file, and the apparatus 1000 further includes: a second acquisition request receiving module configured to, in response to the second layout identification not being included in the set of configuration template files and the first configuration template file, receive a second template acquisition request from the client, the second template acquisition request including the second layout identification; a second selection module configured to select a second configuration template file corresponding to the second layout identification from the plurality of configuration template files; and a second configuration template file sending module configured to send the second configuration template file including the second layout identification to the client to adjust the display of the set of media streams of the set of users in the live streaming using the second layout corresponding to the second layout identification.

In some embodiments, the apparatus 1000 further includes: an acquisition request receiving module configured to, in response to there being no configuration template file for the layout of the media stream of the live streaming at the client, receive an acquisition request for acquiring the parsing engine from the client; and a fourth configuration template file sending module configured to send the parsing engine and a fourth configuration template file including the layout identification to the client to acquire the target layout corresponding to the layout identification using the parsing engine.

In some embodiments, the template configuration file includes the layout style, the maximum number of users participating in the chat of the live streaming, and a display position of a video stream for each user.

FIG. 11 shows a schematic block diagram of an example device 1100 that may be used to implement embodiments of the present disclosure. The computing device client 104, the streamer end 102 and the server 106 in FIG. 1 may be implemented using the device 1100. As shown in the figure, the device 1100 includes a central processing unit (CPU) 1101, which may perform various appropriate actions and processing according to computer program instructions stored in read-only memory (ROM) 1102 or computer program instructions loaded from storage unit 1108 into random access memory (RAM) 1103. In the RAM 1103, various programs and data required for operations of the device 1100 may also be stored. The CPU 1101, the ROM 1102 and the RAM 1103 are connected to each other through a bus 1104. An input/output (I/O) interface 1105 is also connected to the bus 1104.

Multiple components in the device 1100 are connected to the I/O interface 1105, and the components include: an input unit 1106, such as a keyboard, a mouse, etc.; an output unit 1107, such as various types of displays, speakers, etc.; a storage unit 1108, such as a magnetic disk, an optical disc, etc.; and a communication unit 1109, such as a network card, a modem, a wireless communication transceiver, etc. The communication unit 1109 allows the device 1100 to exchange information/data with other devices over a computer network such as Internet and/or various telecommunication networks.

The various processes and treatments described above, such as the methods 200, 300 and 400, may be performed by the processing unit 1101. For example, in some embodiments, the methods 200, 300 and 400 may be implemented as computer software programs tangibly contained in a machine-readable medium such as the storage unit 1108. In some embodiments, a portion or an entirety of the computer program may be loaded and/or installed into the device 1100 via the ROM 1102 and/or the communication unit 1109. When the computer program is loaded into the RAM 1103 and executed by the CPU 1101, one or more actions of the example methods 200, 300 and 400 described above may be performed.

The present disclosure may be a method, an apparatus, a system and/or a computer program product. The computer program product may include a computer-readable storage medium having computer-readable program instructions for performing various aspects of the present disclosure stored thereon.

The computer-readable storage medium may be a tangible device that may hold and store instructions used by an instruction execution device. The computer-readable storage medium may be, for example, but not limited to, an electrical storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanically encoded device such as a punched card or raised structures in a groove with instructions stored thereon, and any suitable combination of the foregoing. The computer-readable storage medium used herein is not interpreted as an instantaneous signal itself, such as a radio wave or other freely propagating electromagnetic waves, electromagnetic waves propagating through a waveguide or other transmission media (e.g., light pulses through an optical fiber cable), or electrical signals transmitted through wires.

The computer-readable program instructions described herein may be downloaded from the computer-readable storage medium to various computing/processing devices, or downloaded to an external computer or an external storage device through a network such as Internet, a local area network, a wide area network, and/or a wireless network. The network may include a copper transmission cable, an optical fiber transmission, a wireless transmission, a router, a firewall, a switch, a gateway computer, and/or an edge server. A network adapter card or a network interface in each computing/processing device receives the computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, including object-oriented programming languages such as Smalltalk, C++, etc., and conventional procedural programming languages such as "C" language or similar programming languages. The computer-readable program instructions may be executed entirely on a user computer, partly executed on a user computer, executed as an independent software package, partly executed on a user computer and partly executed on a remote computer, or entirely executed on a remote computer or a server. In the case involving the remote computer, the remote computer may be connected to the user computer through any kind of network, including a local area network (LAN) or a wide area network (WAN), or it may be connected to an external computer (for example, connected by using Internet provided by an Internet service provider). In some embodiments, by customizing an electronic circuit, such as a programmable logic circuit, a field programmable gate array (FPGA) or a programmable logic array (PLA), using state information of the computer-readable program instructions, the electronic circuit may execute the computer-readable program instructions, thereby implementing various aspects of the present disclosure.

Various aspects of the present disclosure are described herein with reference to flowcharts and/or block diagrams of methods, apparatuses (systems) and computer program products according to embodiments of the present disclosure. It should be understood that each block of the flowchart and/or block diagram, and combinations of blocks in the flowchart and/or block diagram, may be implemented by computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, produce an apparatus for implementing a function/action specified in one or more blocks of the flowchart and/or block diagram. These computer-readable program instructions may also be stored in the computer-readable storage medium, and these instructions cause the computer, the programmable data processing apparatus, and/or other devices to work in a specific manner, so that the computer-readable medium storing the instructions includes a manufactured product, which includes instructions for implementing various aspects of the function/action specified in one or more blocks of the flowchart and/or block diagram.

The computer-readable program instructions may also be loaded onto a computer, other programmable data processing apparatus, or other device, so that a series of operations and steps are performed on the computer, other programmable data processing apparatus, or other device to produce a computer-implemented process, such that the instructions executed on the computer, other programmable data processing apparatus, or other device implement the function/action specified in one or more blocks of the flowchart and/or block diagram.

The flowchart and block diagrams in the drawings show the possibly implemented architectures, functions and operations of the system, method and computer program product according to multiple embodiments of the present disclosure. In this regard, each block in the flowchart or block diagram may represent a module, program segment or part of an instruction, which includes one or more executable instructions for implementing the specified logical function. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and the combination of the blocks in the block diagram and/or the flowchart may be implemented by a special-purpose hardware-based system that executes specified functions or actions, or by a combination of special-purpose hardware and computer instructions.

The embodiments of the present disclosure have been described above. The above description is exemplary, non-exhaustive, and is not limited to the disclosed embodiments. Many modifications and variations will be apparent to those of ordinary skill in the art without departing from the scope and spirit of the described embodiments. The terminology used herein is chosen to best explain the principles of the embodiments, the actual application or the technical improvement to the technology in the market, or to enable other ordinary skilled in the art to understand the embodiments disclosed herein.

1. A method for processing a layout of a media stream, comprising:
sending, from a client to a server, a request associated with a live streaming to receive, from the server, a layout identification corresponding to a target layout of a set of media streams of a set of users in the live streaming;
determining, in response to a set of configuration template files for a layout of a media stream of the live streaming being present at the client, whether the set of configuration template files comprise the target layout based on the layout identification;
sending, in response to the target layout not being comprised in the set of configuration template files, a template acquisition request to the server to receive, from the server, a target configuration template file comprising the layout identification, the template acquisition request comprising the layout identification; and
displaying the set of media streams of the set of users in the live streaming using the target layout corresponding to the layout identification based on the target configuration template file.

2. The method of claim 1, wherein the layout identification is determined based on a layout style received from a streamer end of the live streaming and a maximum number of users participating in a chat of the live streaming.

3. The method of claim 2, wherein the layout identification is a first layout identification, the target layout is a first layout, and the method further comprises:
receiving a second layout identification corresponding to the adjusted target layout in response to the target layout being adjusted by the streamer end during the live streaming;
acquiring a second layout corresponding to the second layout identification from the set of configuration template files and the target configuration template file in response to the second layout identification being comprised in the set of configuration template files and the target configuration template file; and
adjusting a display of the set of media streams of the set of users in the live streaming using the second layout.

4. The method of claim 3, wherein the template acquisition request is a first template acquisition request, and the target configuration template file is a first configuration template file, the method further comprising:
sending, in response to the second layout identification not being comprised in the set of configuration template files and the first configuration template file, a second template acquisition request to the server to receive a second configuration template file comprising the second layout identification from the server, the second template acquisition request comprising the second layout identification; and
adjusting the display of the set of media streams of the set of users in the live streaming based on the second layout in the second configuration template file.

5. The method of claim 3, further comprising:
acquiring the target layout corresponding to the layout identification from a third configuration template file in response to the layout identification being comprised in the third configuration template file in the set of configuration template files; and
displaying the set of media streams of the set of users in the live streaming using the target layout.

6. The method of claim 1, wherein displaying the set of media streams of the set of users in the live streaming using the target layout corresponding to the layout identification comprises:
parsing the target configuration template file using a local parsing engine; and
displaying the set of media streams of the set of users in the live streaming using the target layout corresponding to the layout identification in the parsed target configuration template file.

7. The method of claim 1, wherein determining, based on the layout identification, whether the set of configuration template files comprise the target layout comprises:
determining whether the layout identification exists among multiple layout identifications in the set of configuration template files; and
determining that set of configuration template files do not comprise the target layout in response to the layout identification not existing among the multiple layout identifications.

8. The method of claim 1, further comprising:
determining that a parsing engine available for parsing the configuration template file is not present at the client, in response to a configuration template file for the layout of the media stream of the live streaming not being present at the client;
sending an acquisition request for acquiring the parsing engine to the server;
receiving the parsing engine and a fourth configuration template file comprising the layout identification from the server; and
parsing the fourth configuration template file using the parsing engine to acquire the target layout corresponding to the layout identification.

9. The method of claim 1, wherein the template configuration file comprises a layout style, a maximum number of users participating in a chat of the live streaming, and a display position of a video stream for each user.

10. A method for processing a layout of a media stream, comprising:
sending a layout identification corresponding to a target layout of a set of media streams of a set of users in a live streaming to a client in response to receiving, at a server, a request associated with the live streaming from the client;
receiving a template acquisition request from the client in response to the target layout corresponding to the layout identification not being comprised in a set of configuration template files for a layout of a media stream of the live streaming at the client, the template acquisition request comprising the layout identification;
searching for a target configuration template file comprising the layout identification from a plurality of configuration template files; and
sending the target configuration template file to the client for displaying the set of media streams of the set of users in the live streaming.

11. The method of claim 10, further comprising:
receiving a layout style and a maximum number of users participating in a chat of the live streaming from a streamer end of the live streaming; and
determining the layout identification based on the layout style and the maximum number.

12. The method of claim 11, wherein the layout identification is a first layout identification, the target layout is a first layout, and the method further comprises:
determining a second layout identification corresponding to the adjusted target layout in response to receiving at least one of an adjusted layout style and an adjusted maximum number from the streamer end during the live streaming; and
sending the second layout identification to the client for displaying the set of media streams of the set of users in the live streaming.

13. The method of claim 12, wherein the template acquisition request is a first template acquisition request, and the target configuration template file is a first configuration template file, and the method further comprises:
receiving, in response to the second layout identification not being comprised in the set of configuration template files and the first configuration template file, a second template acquisition request from the client, the second template acquisition request comprising the second layout identification;
selecting a second configuration template file corresponding to the second layout identification from the plurality of configuration template files; and
sending the second configuration template file comprising the second layout identification to the client to adjust the display of the set of media streams of the set of users in the live streaming using the second layout corresponding to the second layout identification.

14. The method of claim 10, further comprising:
receiving an acquisition request for acquiring a parsing engine from the client in response to a configuration template file for the layout of the media stream of the live streaming not being present at the client; and
sending the parsing engine and a fourth configuration template file comprising the layout identification to the client to acquire the target layout corresponding to the layout identification using the parsing engine.

15. The method of claim 10, wherein the template configuration file comprises a layout style, a maximum number of users participating in a chat of the live streaming, and a display position of a video stream for each user.

16. An electronic device, comprising:
at least one processor; and
a storage, configured to store at least one program, the at least one program, when executed by the at least one processor, causing the at least one processor to:
send, from a client to a server, a request associated with a live streaming to receive, from the server, a layout identification corresponding to a target layout of a set of media streams of a set of users in the live streaming;
determine, in response to a set of configuration template files for a layout of a media stream of the live streaming being present at the client, whether the set of configuration template files comprise the target layout based on the layout identification;
send, in response to the target layout not being comprised in the set of configuration template files, a template acquisition request to the server to receive, from the server, a target configuration template file comprising the layout identification, the template acquisition request comprising the layout identification; and
display the set of media streams of the set of users in the live streaming using the target layout corresponding to the layout identification based on the target configuration template file.

17. The electronic device according to claim 16, wherein the layout identification is determined based on a layout style received from a streamer end of the live streaming and a maximum number of users participating in a chat of the live streaming.

18. The electronic device according to claim 17, wherein the layout identification is a first layout identification, the target layout is a first layout, wherein the processor further causes the device to:
receive a second layout identification corresponding to the adjusted target layout in response to the target layout being adjusted by the streamer end during the live streaming;
acquire a second layout corresponding to the second layout identification from the set of configuration template files and the target configuration template file in response to the second layout identification being comprised in the set of configuration template files and the target configuration template file; and
adjust a display of the set of media streams of the set of users in the live streaming using the second layout.

19. The electronic device according to claim 16, the processor causing the device to display the set of media streams of the set of users in the live streaming using the target layout corresponding to the layout identification further causes the deice to:
parse the target configuration template file using a local parsing engine; and
display the set of media streams of the set of users in the live streaming using the target layout corresponding to the layout identification in the parsed target configuration template file.

20. The electronic device according to claim 16, the processor causing the device to determine, based on the layout identification, whether the set of configuration template files comprise the target layout further causes the device to:
determine whether the layout identification exists among multiple layout identifications in the set of configuration template files; and
determine that set of configuration template files do not comprise the target layout in response to the layout identification not existing among the multiple layout identifications.
